(19) United States
(12) Patent Application Publication
(10) Pub. No.: US 2025/0284187 A1
(43) Pub. Date: Sep. 11, 2025

(54) LIGHT UNIFORM MODULE AND PROJECTION DEVICE

(71) Applicant: Coretronic Corporation, Hsin-Chu (TW)

(72) Inventors: YI-CHANG CHEN, Hsin-Chu (TW); SHENG-YU CHIU, Hsin-Chu (TW)

(21) Appl. No.: 19/053,425

(22) Filed: Feb. 14, 2025

Related U.S. Application Data
(60) Provisional application No. 63/563,929, filed on Mar. 11, 2024.

(30) Foreign Application Priority Data
May 9, 2024 (CN) 202420990210.9

(51) Int. Cl. G03B 21/20; F21K 9/65; F21Y 115/10; F21Y 115/30

(52) U.S. Cl. CPC G03B 21/208; F21K 9/65; F21Y 2115/10; F21Y 2115/30; G03B 21/2033

(57) ABSTRACT

A light uniform module includes a light uniform column, a sleeve, and an end fastening member. The light uniform column has a light inlet end and a light outlet end. The light inlet end has a light inlet surface. The light outlet end has a light outlet surface. The sleeve has an open end and a stop end. The sleeve is sleeved outside the light uniform column, and the sleeve accommodates the light uniform column. The end fastening member is disposed at the open end of the sleeve, and the end fastening member fastens relative positions of the light uniform column and the sleeve. The end fastening member has a frame to form a clamping opening, and the light inlet end of the light uniform column penetrates the clamping opening and stretches out of the sleeve from the open end of the sleeve. A projection device is also provided.

### CROSS-REFERENCE TO RELATED APPLICATION

This application claims the priority benefit of the China application (No. 202420990210.9) filed on May 9, 2024 and the U.S. provisional patent application (No. 63/563,929) filed on Mar. 11, 2024. The entirety of the above-mentioned patent applications is hereby incorporated by reference herein and made a part of this specification.

### TECHNICAL FIELD

The disclosure relates to an optical module, and in particular to a light uniform module and a projection device provided with the light uniform module.

### BACKGROUND

Types of light source used in projection devices have evolved from ultra-high pressure mercury lamp (UHP lamp) and light-emitting diode (LED) to laser diode (LD) light source with the market's requirements for brightness, color saturation, service life, non-toxic and environmental protection, and the like of the projection devices. In addition, the projection device is also provided with a light uniform module to homogenize beams generated by a light source module and transmit homogenized beams to a subsequent optical component.

Generally, a light uniform column and a mechanism are provided for the light uniform module, and the light uniform column is fastened in the projection device by using the mechanism. However, to fasten the light uniform column accurately, the existing mechanism needs to be pressed against the light uniform column tightly, resulting in excessive interference of the mechanism with the light uniform column. In this way, the light uniform module is not easily assembled, and the light uniform column is easily scratched by the mechanism. On the contrary, if the interference amount of the mechanism with the light uniform column is reduced, the light uniform column may loosen easily.

The information disclosed in this “BACKGROUND” section is only for enhancement understanding of the background and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

A light uniform module in an embodiment of the disclosure includes a light uniform column, a sleeve, and an end fastening member. The light uniform column is provided with a light inlet end and a light outlet end opposite to each other. The light inlet end is provided with a light inlet surface. The light outlet end is provided with a light outlet surface, and an area of the light inlet surface is smaller than an area of the light outlet surface. The sleeve is provided with an open end and a stop end opposite to each other. The sleeve is sleeved outside the light uniform column, and the sleeve is configured to accommodate the light uniform column. The light outlet end of the light uniform column faces the stop end. The end fastening member is disposed at the open end of the sleeve, and the end fastening member is configured to fasten relative positions of the light uniform column and the sleeve. The end fastening member is provided with a frame to form a clamping opening, and the light inlet end of the light uniform column penetrates the clamping opening and stretches out of the sleeve from the open end of the sleeve.

A projection device in an embodiment of the disclosure includes a light source module, the light uniform module, a light valve, and a projection lens. The light source module is configured to provide an illumination beam. The light uniform module is disposed on a transmission path of the illumination beam. The light uniform module is configured to receive the illumination beam, and the illumination beam enters a light uniform column through a light inlet surface. The illumination beam is totally reflected in the light uniform column and transmitted to a light outlet surface and leaves the light uniform column from the light outlet surface. The light valve is disposed on the transmission path of the illumination beam and is configured to convert the illumination beam emitted from the light uniform module to an image beam. The projection lens is disposed on a transmission path of the image beam and is configured to project the image beam.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a light uniform module according to an embodiment of the present disclosure;

FIG. 2 is a schematic exploded diagram of the light uniform module in FIG. 1;

FIG. 3 is a schematic cross-sectional view of the light uniform module, taken along the line K1-K1 in FIG. 1;

FIG. 4 is a schematic cross-sectional view of the light uniform module, taken along the line K2-K2 in FIG. 1;

FIG. 5 is a schematic cross-sectional diagram of a light uniform module according to another embodiment of the present disclosure;

FIG. 6 is a schematic diagram of an end fastening member in FIG. 5;

FIG. 7 is a schematic cross-sectional diagram of a light uniform module according to another embodiment of the present disclosure;

FIG. 8 is a schematic cross-sectional view of the light uniform module, taken along the line K3-K3 in FIG. 7;

FIG. 9 is a schematic block diagram of a projection device according to an embodiment of the present disclosure; and

FIG. 10 is a schematic diagram of a projection device according to another embodiment of the present disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

The disclosure provides a light uniform module, which is easily assembled, with an assembly yield and assembly firmness taken into account.

The disclosure provides a projection device, which can improve image quality, with the product yield and product durability taken into account.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

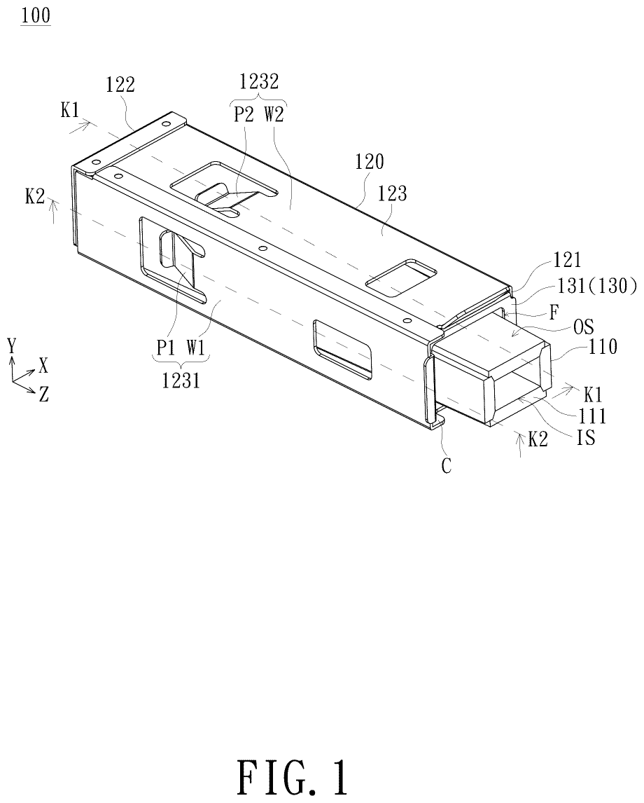

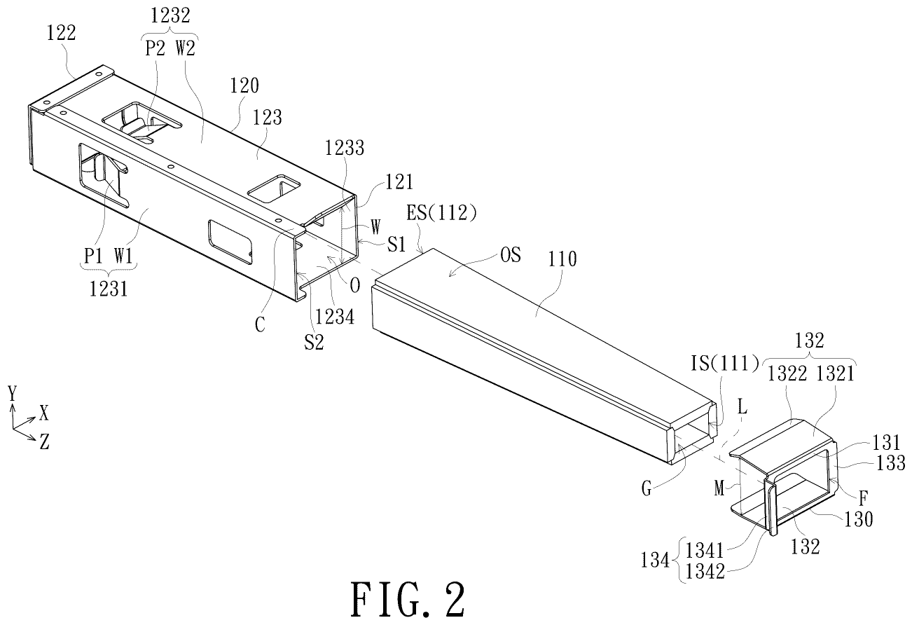

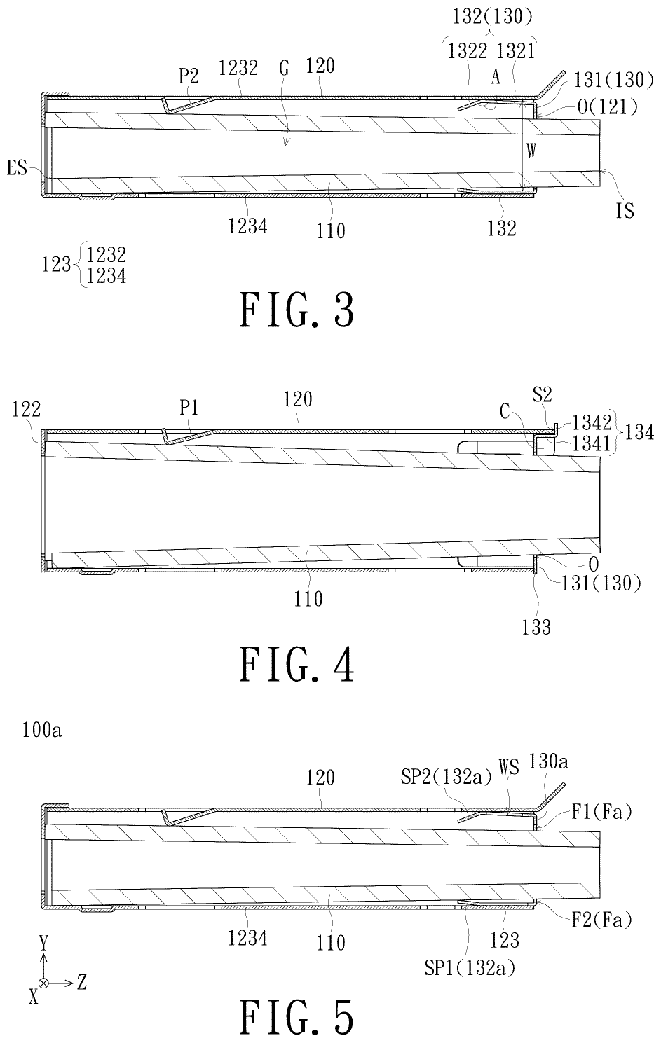

FIG. 1 is a schematic diagram of a light uniform module according to an embodiment of the disclosure. FIG. 2 is a schematic exploded diagram of the light uniform module in FIG. 1. FIG. 3 is a schematic cross-sectional view of the light uniform module, taken along the line K1-K1 in FIG. 1. FIG. 4 is a schematic cross-sectional view of the light uniform module, taken along the line K2-K2 in FIG. 1. Refer to FIG. 1 and FIG. 2. A light uniform module 100 includes a light uniform column 110, a sleeve 120, and an end fastening member 130. The light uniform column 110 is provided with a light inlet end 111 and a light outlet end 112 (drawn in FIG. 2) opposite to each other. The light inlet end 111 is provided with a light inlet surface IS. The light outlet end 112 is provided with a light outlet surface ES (drawn in FIG. 2), and an area of the light inlet surface IS is smaller than an area of the light outlet surface ES. The sleeve 120 is provided with an open end 121 and a stop end 122 opposite to each other. The sleeve 120 is sleeved outside the light uniform column 110, and the sleeve 120 is configured to accommodate the light uniform column 110. The light outlet end 112 of the light uniform column 110 faces the stop end 122. The end fastening member 130 is disposed at the open end 121 of the sleeve 120, and the end fastening member 130 is configured to fasten relative positions of the light uniform column 110 and the sleeve 120. The end fastening member 130 is provided with a frame 131 to form a clamping opening F, and the light inlet end 111 of the light uniform column 110 penetrates the clamping opening F and stretches out of the sleeve 120 from the open end 121 of the sleeve 120.

The light uniform column 110 may be configured to receive an illumination beam. Specifically, the illumination beam can enter the light uniform column 110 through the light inlet surface IS of the light inlet end 111, is totally reflected in the light uniform column 110 and transmitted to the light outlet end 112, and then leaves the light uniform column 110 from the light outlet surface ES. In detail, the light uniform column 110 in this embodiment may be tube-shaped, and therefore, the illumination beam may be transmitted in light guide space G of the light uniform column 110. A sectional area of the light uniform column 110 perpendicular to an optical axis L (drawn in FIG. 2) gradually increases from the light inlet end 111 to the light outlet end 112, for example, the light uniform column 110 in this embodiment may be a tapered rod 110. It should be noted that, because most of the illumination beams are transmitted in the light guide space G of the light uniform column 110, the above sectional area may be a sectional area perpendicular to the optical axis L in the light guide space G.

The sleeve 120 may be provided with a structure for interfering with the light uniform column 110 so that one side of the light uniform column 110 close to the light outlet end 112 is fastened in the sleeve 120. The sleeve 120, for example, also has a sidewall 123. The side wall 123 is located between the open end 121 and the stop end 122 and surrounds the light uniform column 110. The side wall 123 has a wall part 1231 and a wall part 1232 adjacent to each other. The wall part 1231 has a wall body W1 and a pressing piece P1 connected to each other, the wall part 1232 has a wall body W2 and a pressing piece P2 connected to each other, and the pressing piece P1 and the pressing piece P2 are separately configured to press an outer surface OS (drawn in FIG. 2) of the light uniform column 110 close to the light outlet end 112. In this way, the pressing piece P1 and the pressing piece P2 can separately fasten the light uniform column 110 in two different directions. In detail, the side wall 123 may also have a wall part 1233 and a wall part 1234 (both marked in FIG. 2), and the pressing piece P1, for example, pushes the light uniform column 110 against the wall part 1233 in a positive direction X, to prevent the light uniform column 110 from moving in the direction X. Similarly, the pressing piece P2 can push the light uniform column 110 against the wall part 1234 in a negative direction Y to prevent the light uniform column 110 from moving in the direction Y. The wall part 1231 and the wall part 1232 are substantially perpendicular, but the disclosure is not limited thereto.

Incidentally, the wall body W1 and the pressing piece P1 in this embodiment are, for example, integrally formed, and the wall body W2 and the pressing piece P2 may also be integrally formed. Specifically, a part of the wall part 1231 may be cut and bent to form the pressing piece P1, an unbent part of the wall part 1231 may form the wall body W1, and a processing manner for the pressing piece P2 and the wall body W2 is roughly the same as a processing manner for the pressing piece P1 and the wall body W1. In an embodiment, the pressing piece P1 is, for example, a piece additionally connected to the wall body W1, and the pressing piece P2 may be a piece additionally connected to the wall body W2. In other words, the pressing piece P1 and the wall part W1 may be split structures, and the pressing piece P2 and the wall body W2 may also be split structures. For example, the pressing piece P1 may be connected to the wall body W1 by sticking, locking, or the like, and the pressing piece P2 may be connected to the wall body W2 in a manner that is roughly the same as a manner in which the pressing piece P1 is connected to the wall body W1. In this embodiment, a material of the sleeve 120 may include metal, and the metal may include stainless steel, but the disclosure is not limited thereto.

In this embodiment, the end fastening member 130 may abut between the light uniform column 110 and the sleeve 120 to interfere with one side of the light uniform column 110 close to the light inlet end 111. For example, an opening area of the clamping opening F is between an area of the light inlet surface IS and an area of the light outlet surface ES of the light uniform column 110, so that the light uniform column 110 is interfered with the frame 131 to be fastened in the clamping opening F. Further, the frame 131 may be fastened to the open end 121 of the sleeve 120, and an outer surface OS of the light uniform column 110 is clamped through the clamping opening F, so that one side of the light uniform column 110 close to the light inlet end 111 is fastened to the open end 121, and the light inlet end 111 of the light uniform column 110 stretches out of the sleeve 120 from the open end 121.

Refer to FIG. 2 and FIG. 3. In addition, the end fastening member 130 may further be provided with two elastic pieces 132, and the two elastic pieces 132 are respectively connected to two opposite sides of the frame 131. When the end fastening member 130 is fastened to the open end 121 of the sleeve 120, the two elastic pieces 132 are located in the sleeve 120, and the two elastic pieces 132 separately push against the side wall 123 in directions away from each other. In this way, the end fastening member 130 may be fastened in the sleeve 120 by interference of the two elastic pieces 132 with the side wall 123. In detail, the open end 121 of the sleeve 120 may have an open part O, and a maximum spacing M (marked in FIG. 2) between the two elastic pieces 132 may be greater than the width W of the open part O. Therefore, after extending into the sleeve 120 from the open part O, the two elastic pieces 132 may be compressed by the wall part 1232 and the wall part 1234 to produce a reaction force to push against the wall part 1232 and the wall part 1234, and then fastened in the sleeve 120 by interfering with the side wall 123. Incidentally, a material of the end fastening member 130 may include metal, and the metal includes, for example, stainless steel, but the disclosure is not limited thereto.

In this embodiment, each of the two elastic pieces 132 may be provided with a pushing part 1321 and a guide part 1322. The pushing part 1321 is connected to the frame 131, and the frame 131 and the guide part 1322 are located on two opposite sides of the pushing part 1321. The guide part 1322 is connected to the pushing part 1321, and the guide part 1322 is bent toward the other guide part 1322 relative to the connected pushing part 1321. Therefore, the end fastening member 130 can more easily extend into the sleeve 120 through the guidance of the guide part 1322, so that the light uniform module 100 is assembled more easily. Incidentally, an angle A (marked in FIG. 3) between the guide part 1322 and the pushing part 1321 of each of the two elastic pieces 132 is, for example, an obtuse angle, to further enhance the guidance effect provided by the guide part 1322 when the end fastening member 130 extends into the sleeve 120. It should be noted that the above maximum spacing M between the two elastic pieces 132 is, for example, a spacing between two junctions of the two pushing parts 1321 and the two second guide parts 1322 that are connected correspondingly.

Refer to FIG. 2 and FIG. 4. The end fastening member 130 may further be provided with at least one limiting structure, and for example, one limiting structure 133 (drawn in FIG. 2) and one limiting structure 134 are provided in this embodiment. The limiting structure 133 and the limiting structure 134 are connected to the frame 131, and the limiting structure 133 is configured to lean against the open end 121 from a supporting surface S1 (drawn in FIG. 2) of the open end 121 of the sleeve 120, and the limiting structure 134 is configured to lean against the open end 121 from a supporting surface S2 (drawn in FIG. 2), to control a distance for which the end fastening member 130 extends into the sleeve 120. A shape of the limiting structure 133 and the limiting structure 134 may be changed based on a shape of the open end 121 of the sleeve 120. For example, the limiting structure 133 may be located between the two elastic pieces 132 and can protrude from the frame 131 along the positive direction X, to lean against the supporting surface S1. Further, the open end 121 is, for example, frame-shaped, and an end surface on a frame-shaped side may be the supporting surface S1.

In one embodiment, the open end 121 of the sleeve 120 may further be provided with, for example, a protruding part C. The light uniform column 110 stretches out of the open part O. The protruding part C protrudes from the open part O in a positive direction Z away from the stop end 122, and the supporting surface S2 is located at the protruding part C. The limiting structure 134 is, for example, provided with an extension section 1341 and a stop section 1342. The extension section 1341 is connected to the frame 131, and the frame 131 and the stop section 1342 are located on two opposite sides of the extension section 1341. The stop section 1342 is connected to the extension section 1341 and is bent relative to the extension section 1341. The stop section 1342 is configured to lean against the protruding part C from the supporting surface S2 of the sleeve 120. Simply, the extension section 1341 may extend along the positive direction Z away from the open end 121 to match the length of the protruding part C protruding from the open part O, so that the stop section 1342 can lean against the protruding part C when the end fastening member 130 extends into the sleeve 120, and then a distance for which the end fastening member 130 extends into the sleeve 120 can be controlled. Still refer to FIG. 2. In this embodiment, the limiting structure 133 and the limiting structure 134 are opposite each other, and the stop section 1342 and the limiting structure 133 can protrude from the frame 131 in opposite directions. However, in one embodiment, the end fastening member 130 may be provided with only the limiting structure 133 or the limiting structure 134. In another embodiment, a quantity of the limiting structure 133 or the limiting structure 134 may be one or more than two, and the disclosure is not limited thereto.

Still refer to FIG. 1 and FIG. 2. The assembly steps for the light uniform module 100 in this embodiment are described below. First, the light outlet end 112 of the light uniform column 110 is extended into the sleeve 120 from the open part O of the open end 121 of the sleeve 120, until the light uniform column 110 is fastened in the sleeve 120 by interference of the two pressing pieces P1 and P2 on one side close to the light outlet end 112. In addition, the stop end 122 can stop the light outlet end 112 of the light uniform column 110 in the sleeve 120, and the light inlet end 111 of the light uniform column 110 stretches out of the sleeve 120 from the open part O. Next, the end fastening member 130 is sleeved on the light uniform column 110 from the light inlet end 111 of the light uniform column 110, until the end fastening member 130 is fastened between the light uniform column 110 and the sleeve 120 by the interference of the light uniform column 110 and the sleeve 120. The assembly for the light uniform module 100 is completed after the end fastening member 130 is fastened between the light uniform column 110 and the sleeve 120. Incidentally, the above assembly steps are only an example and are not intended to limit the disclosure.

Compared with the existing technologies, for the light uniform module 100 in this embodiment, the sleeve 120 is used to fasten one side of the light uniform column 110 close to the light outlet end 112, and the end fastening member 130 is used to fasten the light uniform column 110 on one side close to the light inlet end 111. In this way, a structure used to interfere with the light uniform column 110 near the open end 121 may be omitted for the sleeve 120, so that a thicker side (i.e., the side close to the light outlet end 112) of the light uniform column 110 is not damaged by excessive interference of the structure while extending into the sleeve 120 from the open end. In addition, the end fastening member 130 uses the clamping opening F of the frame 131 to interfere with a thinner side (i.e., the side close to the light inlet end 111) of the light uniform column 110. Therefore, when the end fastening member 130 is sleeved from the light inlet end 111 to the light uniform column 110, the frame 131 does not touch the light uniform column 110 before interfering with the light uniform column 110, and the frame 131 can achieve the effect of fastening the light uniform column 110 by slight interference, thereby reducing the damage of the end fastening member 130 to the light uniform column 110. In addition, because the end fastening member 130 and the sleeve 120 both have a function of fastening the light uniform column 110, an interference amount of the sleeve 120 to the light uniform column 110 can be further reduced. In this case, the light uniform column 110, the sleeve 120, and the end fastening member 130 can still be firmly fastened to each other. Based on the above structure, the light uniform module 100 in this embodiment has an advantage of being easily assembled, with an assembly yield and assembly firmness taken into account.

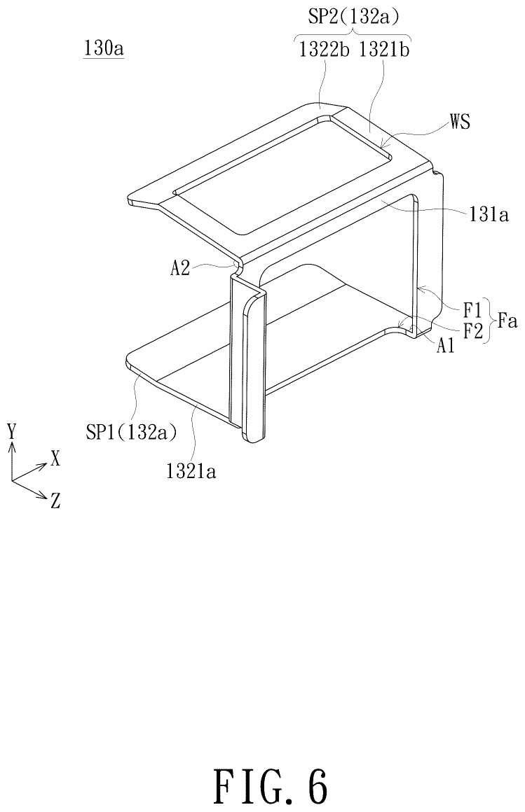

FIG. 5 is a schematic cross-sectional diagram of a light uniform module according to another embodiment of the disclosure. FIG. 6 is a schematic diagram of an end fastening member in FIG. 5. A structure and advantages of the light uniform module 100a in this embodiment are similar to the structure and advantages of the embodiment in FIG. 1, and only differences are described below. Refer to FIG. 5 and FIG. 6. Two elastic pieces 132a of the end fastening member 130a include a first elastic piece SP1 and a second elastic piece SP2. A clamping opening Fa may have a clamping region F1 and an extension region F2 communicated to each other. A light uniform column 110 penetrates the clamping region F1. The extension region F2 extends from the clamping region F1 to the first elastic piece SP1, and the second elastic piece SP2 is provided with a structural strength weakening part WS corresponding to the extension region F2. Specifically, because the extension region F2 may weaken the structural strength of the first elastic piece SP1, the structural strength of the second elastic piece SP2 may be weakened by the structural strength weakening part WS, to match the structural strength of the first elastic piece SP1. The structural strength weakening part WS may be an opening penetrating the second elastic piece SP2, which is not limited thereto. In another embodiment, the structural strength weakening part WS may be a plurality of holes penetrating the second elastic piece SP2 or another material different from a material of the second elastic piece SP2, thereby weakening the structural strength of the second elastic piece SP2. In this way, in a case the structural strength of the first elastic piece SP1 and the second elastic piece SP2 is changed, the first elastic piece SP1 and the second elastic piece SP2 can be maintained to push against the sleeve 120 with approximately same thrusts, so that a frame 131a can clamp the light uniform column 110 with approximately same forces on two opposite sides connecting the first elastic piece SP1 and the second elastic piece SP2, to prevent the light uniform column 110 from tilting due to uneven thrusts exerted by the first elastic piece SP1 and the second elastic piece SP2 on the sleeve 120.

Still refer to FIG. 6. In this embodiment, the extension region F2, for example, extends from the clamping region F1 to a pushing part 1321a of the first elastic piece SP1 and can penetrate the first elastic piece SP1 in a direction Y. In addition, the structural strength weakening part WS can penetrate a pushing part 1321b and a guide part 1322b of the second elastic piece SP2 in the direction Y, and be separated from the clamping region F1. However, because features of the structural strength weakening part WS can be changed based on features of the extension region F2, the disclosure does not limit this. In addition, the clamping region F1 in this embodiment, for example, corresponds to the open end 121 of the sleeve 120, and the light inlet end 111 of the light uniform column 110 can stretch out of the sleeve 120 through the clamping region F1. In addition, the extension region F2 may be corresponding to a side wall 123 of the sleeve 120, that is, the extension region F2 can expose a part of the side wall 123 after the end fastening member 130a is fastened to the sleeve 120. Incidentally, an angle A1 between the pushing part 1321a of the first elastic piece SP1 and the clamping region F1 may be smaller than an angle A2 between the pushing part 1321b of the second elastic piece SP2 and the frame 131a.

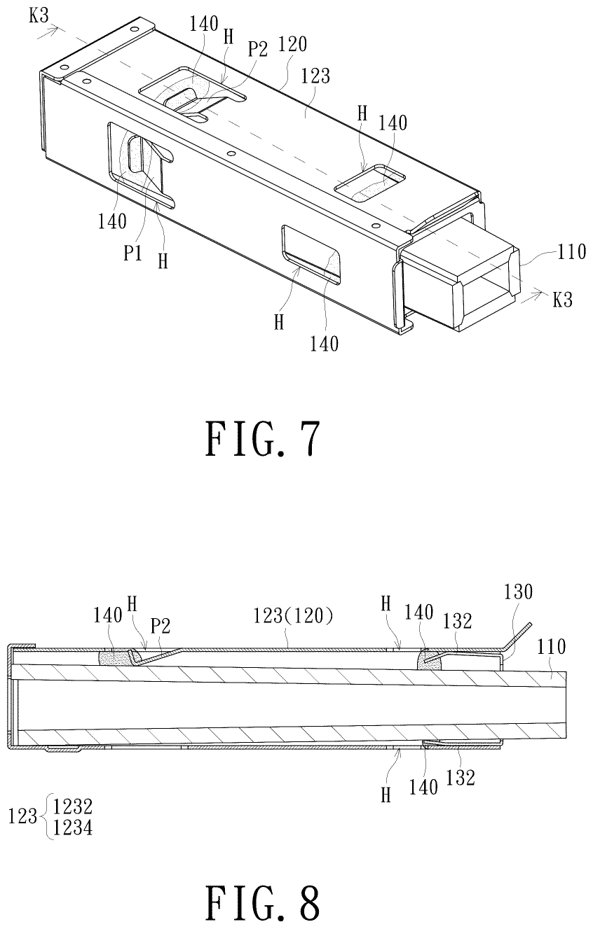

FIG. 7 is a schematic cross-sectional diagram of a light uniform module according to another embodiment of the disclosure. FIG. 8 is a schematic cross-sectional view of the light uniform module, taken along the line K3-K3 in FIG. 7. A structure and advantages of a light uniform module 100b in this embodiment are similar to the structure and advantages of the embodiment in FIG. 1, and only differences are described below. Refer to FIG. 7 and FIG. 8. For example, the light uniform module 100b further includes at least one glue material 140, and for example, a plurality of glue materials 140 are used in this embodiment. A side wall 123 is provided with, for example, at least one glued through hole H, and for example, a plurality of glued through holes H are used in this embodiment. The glue material 140 is disposed in the glued through hole H to connect at least two of a light uniform column 110, a sleeve 120, and an end fastening member 130. In this way, the glue material 140 can strengthen the fastening of the light uniform column 110, the sleeve 120, and the end fastening member 130 to enhance the assembly firmness of the light uniform module 100b. In this embodiment, the glue material 140 may be disposed in the glued through hole H after assembly for the light uniform module 100b is completed. Further, one part of the glue material 140 may be connected to the light uniform column 110, a pressing piece P1, and a pressing piece P2, and the other part of the glue material 140 may be connected to the light uniform column 110 and two elastic pieces 132. In one embodiment, the glue material 140 may be connected to the light uniform column 110, the sleeve 120, and the end fastening member 130. Incidentally, the glue material 140 in this embodiment includes, for example, an ultraviolet curing adhesive, but the disclosure is not limited thereto.

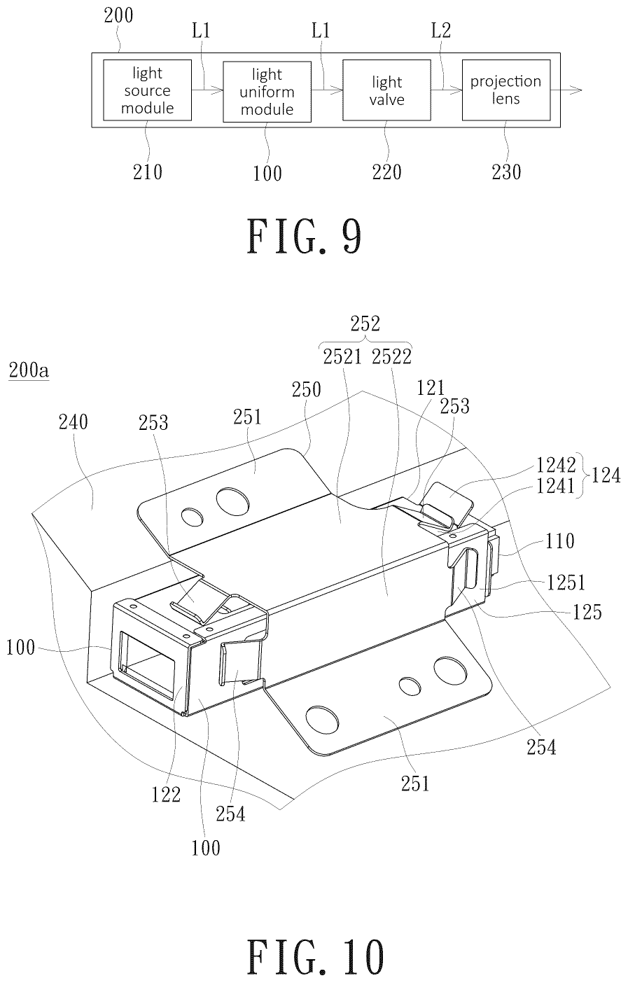

FIG. 9 is a schematic block diagram of a projection device according to an embodiment of the disclosure. Refer to FIG. 3 and FIG. 9. A projection device 200 includes a light source module 210, a light uniform module 100, a light valve 220, and a projection lens 230. The light source module 210 is configured to provide an illumination beam L1. The light uniform module 100 is disposed on a transmission path of the illumination beam L1. The light uniform module 100 may be any of the light uniform modules in the above embodiments. The light uniform module 100 is configured to receive the illumination beam L1, and the illumination beam L1 enters a light uniform column 110 through a light inlet surface IS. The illumination beam L1 is totally reflected in the light uniform column 110 and transmitted to a light outlet surface ES and leaves the light uniform column 110 from the light outlet surface ES. The light valve 220 is disposed on the transmission path of the illumination beam L1 and is configured to convert the illumination beam L1 emitted from the light uniform module 100 to an image beam L2. The projection lens 230 is disposed on a transmission path of the image beam L2 and is configured to project the image beam L2.

The light source module 210 may include an excitation light source. In detail, the excitation light source includes, for example, a light emitting diode (LED) or a laser diode (LD), and a quantity of the light-emitting diodes or laser diodes may be one or more. For example, when there is a plurality of LEDs (or LDs), the LEDs (or LDs) may be arranged in a matrix. In an embodiment, the excitation light source includes, for example, a monochromatic light source and a wavelength conversion component may be disposed downstream of an optical path of the excitation light source. In another embodiment, the excitation light source may include a multi-color light source.

In this embodiment, the light inlet surface IS of the light uniform column 110 may be used for the illumination beam L1 to enter light guide space G, and is transmitted to the light outlet surface ES in the light guide space G in a total reflection manner, and then leaves the light uniform column 110 from the light outlet surface ES. Specifically, the light inlet surface IS and the light outlet surface ES may include openings that communicate with each other in the light guide space G for the illumination beam L1 to penetrate. It can be understood that the stop end 122 of the sleeve 120 may be provided with an opening that communicates with the light guide space G so that the illumination beam L1 can be emitted from the light uniform module 100. Other features of the light uniform module 100 have been described above, and no redundant detail is to be given herein.

The light valve 220 includes, for example, a digital micromirror device (DMD), a liquid crystal on silicon (LCoS), or a liquid crystal display panel (LCD), but the disclosure is not limited thereto. In addition, a quantity of the light valves 220 is not limited in the disclosure. For example, the projection device 200 in this embodiment may adopt an architecture of a single-piece liquid crystal display panel or a three-piece liquid crystal display panel, but the disclosure does not limit this.

The projection lens 230 in this embodiment may include one or more optical lenses, and a diopter brightness of the optical lenses may be the same or different from each other. For example, the optical lens may include various non-planar lenses, such as biconcave lenses, biconvex lenses, concave-convex lenses, convex-concave lenses, plano-convex lenses, and plano-concave lenses, or any combination of the above non-planar lenses. In addition, the projection lens 230 may further include a flat optical lens. A specific structure of the projection lens 230 is not limited in the disclosure.

Compared with the existing technology, the light uniform module 100 is used for the projection device 200 in this embodiment, so that image quality can be improved, with the product yield and product durability taken into account. It can be understood that, in an embodiment, the projection device 200 may alternatively be a light uniform module 100a or 100b.

FIG. 10 is a schematic diagram of a projection device according to another embodiment of the disclosure. A structure and advantages of a projection device 200a in this embodiment are similar to the structure and advantages of the embodiment in FIG. 9, and only the differences are described below. Refer to FIG. 10. The projection device 200a includes, for example, a base 240 and a fastened member 250. A light uniform module 100 is disposed on the base 240. The fastened member 250 is fastened on the base 240 and pressed against a sleeve 120 of the light uniform module 100, to fasten the light uniform module 100 on the base 240. In detail, the fastened member 250 may be provided with two fastened parts 251, a body part 252, and two first pressing parts 253. The two fastened parts 251 are connected to two opposite sides of the body part 252. The two first pressing parts 253 are connected to two opposite sides of the body part 252 and are respectively located between the two fastened parts 251. The two fastened parts 251 are fastened to the base 240. The body part 252 covers the sleeve 120 of the light uniform module 100, and the two first pressing parts 253 are pressed against the sleeve 120. Further, the body part 252 can protect the light uniform module 100, and the two first pressing parts 253 can prevent the light uniform module 100 from shifting relative to the base 240. Incidentally, the two fastened parts 251 may be attached to the base 240 through a screw lock, which is not limited thereto in another embodiment.

The sleeve 120 in this embodiment is provided with, for example, a first pressed wall 124, and the first pressed wall 124 is located between the light uniform column 110 and the two first pressing parts 253 of the fastened member 250. The first pressed wall 124 may be provided with a main body 1241 and a protective reinforcing part 1242. The main body 1241 extends from a stop end 122 of the sleeve 120 to an open end 121. The protective reinforcing part 1242 is connected to one side of the main body 1241 located at the open end 121, and the two first pressing parts 253 are pressed against the main body 1241 and/or the protective reinforcing part 1242. For example, in this embodiment, one of the first pressing parts 253 is pressed against the main body 1241, and the other of the first pressing parts 253 is pressed against the main body 1241 and the protective reinforcing part 1242. In this way, the protective reinforcing part 1242 can stop the first pressing part 253 at the open end 121 of the sleeve 120, preventing the first pressing part 253 from moving from the main body 1241 to the light uniform column 110 and scratching the light uniform column 110. Incidentally, the protective reinforcing part 1242 is for example, plate-shaped, and the protective reinforcing part 1242 can be bent relative to the main body 1241 in a direction away from the light uniform column 110, to exactly stop the first pressing part 253 on the main body 1241. The protective reinforcing part 1242 is not limited thereto. In another embodiment, the protective reinforcing part 1242 may protrude from the open end 121 of the sleeve 120 to stop the first pressing part 253 on the main body 1241.

In addition, the fastened member 250 may further be provided with two second pressing parts 254. The body part 252 of the fastened member 250 is provided with a first plate body 2521 and a second plate body 2522 connected to each other. The two first pressing parts 253 connect two opposite sides of the first plate body 2521, and the two second pressing parts 254 connect two opposite sides of the second plate body 2522. The sleeve 120 has a second pressed wall 125 adjacent to the first pressed wall 124. The first plate body 2521 corresponds to the first pressed wall 124, and the two first pressing parts 253 are pressed against the first pressed wall 124. The second plate body 2522 is corresponding to the second pressed wall 125, and the two second pressing parts 254 are pressed against the second pressed wall 125. In this way, the two first pressing parts 253 and the two second pressing parts 254 can simultaneously press the light uniform module 100 against the base 240 to strengthen the firmness that the light uniform module 100 is fastened to the base 240. Incidentally, the second pressed wall 125 is provided with, for example, the protective reinforcing part 1251, and the protective reinforcing part 1251 can protrude from the open end 121 of the sleeve 120, to prevent the second pressing part from scratching the light uniform column 110. It should be noted that the protective reinforcing part 1251 is, for example, the protruding part C in FIG. 1, the first pressed wall 124 may be the wall part 1232 in FIG. 1, and the second pressed wall 125 may be the wall part 1231 in FIG. 1. In another embodiment, the protective reinforcing part 1251 may alternatively be the protective reinforcing part 1242 in a plate shape, which is not limited thereto.

In summary, for the light uniform module in the disclosure, the sleeve is used to fasten one side of the light uniform column close to the light outlet end, and the end fastening member is used to fasten the light uniform column on one side close to the light inlet end. In this way, a structure used to interfere with the light uniform column near the open end may be omitted for the sleeve, so that a thicker side (i.e., the side close to the light outlet end) of the light uniform column is not damaged by excessive interference of the structure while extending into the sleeve from the open end. In addition, the end fastening member uses the clamping opening of the frame to interfere with a thinner side (i.e., the side close to the light inlet end) of the light uniform column. Therefore, when the end fastening member is sleeved from the light inlet end to the light uniform column, the frame does not touch the light uniform column before interfering with the light uniform column, and the frame can achieve the effect of fastening the light uniform column by slight interference, thereby reducing the damage of the end fastening member to the light uniform column. In addition, because the end fastening member and the sleeve both have a function of fastening the light uniform column, an interference amount of the sleeve to the light uniform column can be further reduced. In this case, the light uniform column, the sleeve, and the end fastening member can still be firmly fastened to each other. Based on the above structure, the light uniform module in the disclosure has an advantage of being easily assembled, with an assembly yield and assembly firmness taken into account. The light uniform module is used for the projection device in the disclosure, so that image quality can be improved, with the product yield and product durability taken into account.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. A light uniform module, comprising a light uniform column, a sleeve, and an end fastening member, wherein:
the light uniform column is provided with a light inlet end and a light outlet end opposite to each other, the light inlet end is provided with a light inlet surface, the light outlet end is provided with a light outlet surface, and an area of the light inlet surface is smaller than an area of the light outlet surface;
the sleeve is provided with an open end and a stop end opposite to each other, the sleeve is sleeved outside the light uniform column to accommodate the light uniform column, and the light outlet end of the light uniform column faces the stop end; and
the end fastening member is disposed at the open end of the sleeve to fasten relative positions of the light uniform column and the sleeve, and the end fastening member is provided with a frame to form a clamping opening, wherein the light inlet end of the light uniform column penetrates the clamping opening and stretches out of the sleeve from the open end of the sleeve.

2. The light uniform module according to claim 1, wherein the sleeve further has a side wall, the side wall is located between the open end and the stop end and surrounds the light uniform column, the end fastening member is further provided with two elastic pieces, and the two elastic pieces are respectively connected to two opposite sides of the frame, wherein when the end fastening member is fastened to the open end of the sleeve, the two elastic pieces are located in the sleeve and separately push against the side wall in directions away from each other.

3. The light uniform module according to claim 2, wherein each of the two elastic pieces is provided with a pushing part and a guide part, the pushing part is connected to the frame, the frame and the guide part are located on two opposite sides of the pushing part, the guide part is connected to the pushing part, and the guide part is bent toward the other guide part relative to the connected pushing part.

4. The light uniform module according to claim 3, wherein an angle between the guide part and the pushing part of each of the two elastic pieces is an obtuse angle.

5. The light uniform module according to claim 2, wherein the two elastic pieces comprise a first elastic piece and a second elastic piece, the clamping opening is provided with a clamping region and an extension region communicated with each other, the light uniform column penetrates the clamping region, the extension region extends from the clamping region to the first elastic piece, and the second elastic piece is provided with a structural strength weakening part corresponding to the extension region.

6. The light uniform module according to claim 1, wherein the end fastening member is further provided with at least one limiting structure, the at least one limiting structure is connected to the frame, and the at least one limiting structure is configured to lean against the open end from a supporting surface of the open end of the sleeve.

7. The light uniform module according to claim 6, wherein the open end of the sleeve is provided with an open part and a protruding part, the light uniform column stretches out from the open part, the protruding part protrudes from the open part in a direction away from the stop end, the supporting surface is located at the protruding part, the at least one limiting structure is provided with an extension section and a stop section, the extension section is connected to the frame, the frame and the stop section are located on two opposite sides of the extension section, the stop section is connected to the extension section and bent relative to the extension section, and the stop section is configured to lean against the protruding part from the supporting surface of the sleeve.

8. The light uniform module according to claim 1, wherein the sleeve further has a side wall, the side wall is located between the open end and the stop end and surrounds the light uniform column, the side wall is provided with two wall parts adjacent to each other, each of the two wall parts is provided with a wall body and a pressing piece connected to each other, and the pressing piece is configured to press the light uniform column to be close to an outer surface of the light outlet end.

9. The light uniform module according to claim 8, wherein the wall body and the pressing piece are integrally formed, or the pressing piece is a piece additionally connected to the wall body.

10. The light uniform module according to claim 1, further comprising at least one glue material, wherein the sleeve further has a side wall, the side wall is located between the open end and the stop end and surrounds the light uniform column, the side wall is provided with at least one glued through hole, and the at least one glue material is disposed in the at least one glued through hole to connect at least two of the light uniform column, the sleeve, and the end fastening member.

11. The light uniform module according to claim 1, wherein an opening area of the clamping opening is between an area of the light inlet surface of the light uniform column and an area of the light outlet surface.

12. A projection device, comprising a light source module, a light uniform module, a light valve, and a projection lens, wherein:
the light source module is configured to provide an illumination beam;
the light uniform module is disposed on a transmission path of the illumination beam, the light uniform module comprises a light uniform column, a sleeve, and an end fastening member, the light uniform column is configured to receive the illumination beam, the light uniform column is provided with a light inlet end and a light outlet end opposite to each other, the light inlet end is provided with a light inlet surface, the light outlet end is provided with a light outlet surface, the illumination beam enters the light uniform column from the light inlet surface, the illumination beam is totally reflected in the light uniform column and transmitted to the light outlet surface and leaves the light uniform column from the light outlet surface, an area of the light inlet surface of the light uniform column is smaller than an area of the light outlet surface, the sleeve is provided with an open end and a stop end opposite to each other, the sleeve is sleeved outside the light uniform column to accommodate the light uniform column, the light outlet end of the light uniform column faces the stop end, the end fastening member is disposed at the open end of the sleeve to fasten relative positions of the light uniform column and the sleeve, the end fastening member is provided with a frame to form a clamping opening, and the light inlet end of the light uniform column penetrates the clamping opening and stretches out of the sleeve from the open end of the sleeve;
the light valve is disposed on the transmission path of the illumination beam and is configured to convert the illumination beam emitted from the light uniform module to an image beam; and
the projection lens is disposed on a transmission path of the image beam and is configured to project the image beam.

13. The projection device according to claim 12, further comprising a base and a fastened member, wherein the light uniform module is disposed on the base, and the fastened member is fastened to the base and pressed against the sleeve of the light uniform module.

14. The projection device according to claim 13, wherein the fastened member is provided with two fastened parts, a body part, and two first pressing parts, the two fastened parts are respectively connected to two opposite sides of the body part, the two first pressing parts are respectively connected to the two opposite sides of the body part and are separately located between the two fastened parts, the two fastened parts are fastened to the base, the body part covers the sleeve of the light uniform module, and the two first pressing parts are pressed against the sleeve.

15. The projection device according to claim 14, wherein the sleeve is provided with a first pressed wall, the first pressed wall is located between the light uniform column and the two first pressing parts of the fastened member, the first pressed wall is provided with a main body and a protective reinforcing part, the main body extends from the stop end of the sleeve to the open end, the protective reinforcing part is connected to one side of the main body located at the open end, and the two first pressing parts are pressed against the main body and/or the protective reinforcing part.

16. The projection device according to claim 15, wherein the protective reinforcing part is plate-shaped, and the protective reinforcing part protrudes from the open end or is bent relative to the main body in a direction away from the light uniform column.

17. The projection device according to claim 14, wherein the fastened member is further provided with two second pressing parts, the body part of the fastened member is provided with a first plate body and a second plate body connected to each other, the two first pressing parts are connected to two opposite sides of the first plate body, the two second pressing parts are connected to two opposite sides of the second plate body, the sleeve is provided with a first pressed wall and a second pressed wall adjacent to each other, the first plate body is corresponding to the first pressed wall, the two first pressing parts are pressed against the first pressed wall, the second plate body is corresponding to the second pressed wall, and the two second pressing parts are pressed against the second pressed wall.
